(19) United States
(12) Patent Application Publication
(10) Pub. No.: US 2004/0087736 A1
(43) Pub. Date: May 6, 2004

(54) Powder coating compositions containing anhydride end-capped crystalline polyesters

(76) Inventors: Bin Wu, Marietta, GA (US); Luc Moens, Sint-Genesius-Rode (BE)

Correspondence Address: WENDEROTH, LIND & PONACK, L.L.P., 2033 K STREET N. W., SUITE 800, WASHINGTON, DC, 20006-1021, US

(21) Appl. No.: 10/286,872

(22) Filed: Nov. 4, 2002

(51) Int. Cl. C08F 20/08; C08F 20/00

(52) U.S. Cl. 525/438

(57) ABSTRACT

Thermosetting coating compositions containing amorphous and semi-crystalline polyesters are provided. They are useful in coating compositions, especially for low temperature powder coating applications. Novel semi-crystalline polyesters useful in the above coating compositions are also provided.

### BACKGROUND OF THE INVENTION

This invention relates to a carboxylic acid anhydride end-capped crystalline polyester and thermosetting coating compositions containing said polyester in powder coating applications, and more particularly in low temperature cure powder coating applications.

Powder coating applications are considered green chemistry process because their compositions greatly reduce or completely eliminate the organic solvents used in liquid paints. When they are thermally cured, no or very little volatile organic compounds (VOC) are released to the surrounding environment.

A typical thermoset powder coating formulation consists of a polymeric binder, curative, pigment, flow aid, degassing agent and curing catalyst. Among all binders polyesters are widely used because they provide excellent weathering resistance and mechanical properties as well as good appearance. Polyester resins have either hydroxyl or carboxyl groups at their chain ends. Hydroxyl functional polyesters are typically formulated with a blocked isocyanate curative to form a polyester-urethane powder coating. Carboxyl functional polyesters may be formulated with a crosslinker such as triglycidyl isocyanurate, TGIC, polyepoxy resins and other compounds or polymers which contain functional groups reactable with carboxylic acid groups to form thermosetting networks. Powder coating compositions using carboxylated polyester and TGIC curative give coatings with good exterior durability, and the powder coatings using polyepoxy resins as curatives are mainly for interior applications. The polyester resins in powder coating compositions usually possess a glass transition temperature of above 50° C., which allows the powder coating composition to have storage stability without sintering.

Powder coating formulations are typically mixed, extruded, pulverized, classified and electrostatically applied onto substrates. The coated parts are then baked at elevated temperatures.

Currently, the great majority of polyesters used in heat-curable powder compositions are amorphous polyesters. When the polyester is amorphous, it is difficult to prepare perfect heat-curable powdered compositions because they have to meet often contradictory criteria. Thus, these powders may not re-agglomerate during handling, transportation and storage, which implies that the amorphous polyester must possess a sufficiently high glass transition temperature (T_{g}). On the other hand, in order for the powder particles to be able to coalesce and to form a perfectly homogeneous and uniform coating, it is necessary for the T_{g} of the polyester to be sufficiently low to ensure a low viscosity in the molten state which itself ensures good wetting of the pigments and other solid materials accompanying the polyester in the formulation of the said heat-curable powder compositions.

Moreover, the powder must be capable of melting at the stoving temperature in order to form an even film before the crosslinking reaction begins which results in the final curing. In order to obtain good spreading of the molten film over the surface of the substrates, it is therefore necessary for the viscosity of the polyester in the molten state to be sufficiently low. This is because a very high viscosity in the molten state prevents good spreading of the molten film and is reflected by a loss in the evenness and gloss of the coating. Finally, the rate of the crosslinking reaction is controlled by varying the temperature, the amount and/or the nature of the curative and that of the curing catalyst, which is optionally used.

For all these reasons, it is not generally recommended to produce coatings from compositions based on such amorphous polyesters by stoving at temperatures below 160° C. for approximately 10 to 20 minutes.

There is increasing market interest in applying powder coatings on heat-sensitive substrates such as wood, plastics and medium-density fibreboard (MDF). In order to fulfil these needs, cure temperatures must be lowered to below 150° C. However, at low temperatures, powders tend to cure incompletely and do not flow effectively. Incomplete cure and poor flow can cause many property defects such as adhesion failure, poor chemical resistance, poor mechanical properties, orange peel, etc.

Accordingly, it is an object of the present invention to provide thermosetting powder coating compositions which, upon application and curing at low temperatures, provide finishes which overcome all these negative aspects.

It now has been surprisingly found that a binder composition comprising a carboxylic acid group containing amorphous polyester, a particular carboxylic acid anhydride end-capped semi-crystalline polyester and a glycidyl group containing polyphenoxy resin curative, when applied and cured at temperatures of from 80 to 150° C. for 5-30 minutes, affords coatings having good adhesion to metallic and non-metallic surfaces, excellent flow, outstanding flexibility and chemical resistance. The composition can optionally contain one or more curing agents having functional groups reactable with the polyesters' carboxylic acid groups,

Powder coating compositions based on semicrystalline polyesters have already formed the subject of a certain number of publications in the form of papers and patents, in particular U.S. Pat. Nos. 4,352,924, 3,387,214, 4,937,288 and 4,973,646.

EP 521992B 1 describes a powder coating composition containing an amorphous and a semi-crystalline polyester resin. The semi-crystalline resin has an acid number of from 10 to 70 mg KOH/g. The purpose of adding the crystalline polyester is to improve the flow of the powder coating.

U.S. Pat. No. 4,937,288 describes a powder coating system having an improved flow property that consists of a carboxyl functional acrylic polymer, a crystalline polyester and a beta-hydroxyalkylamide curing agent. The crystalline polyester has an acid number of from about 150 to 750 mg KOH/g. The system is limited to beta-hydroxyalkylamide curative and is not related to low-temperature cure powder coatings.

U.S. Pat. No. 6,407,181 describes a powder coating composition based on a glycidyl (meth)acrylate copolymer and a low-viscosity carboxylic acid functional polyester, which provides a smooth, weatherable, reduced gloss coating for use on heat sensitive substrates. According to that patent, the low-viscosity carboxylic acid functional polyesters are generally linear but may be capped with trimellitic anhydride to provide a functionality of 4. The said polyesters have acid numbers between 20 and 60 mg KOH/g, and glass transition temperatures between 40 and 80° C. Depending upon the gloss reduction desired, the low viscosity polyesters can be replaced by or blended with a crystalline polyester. Neither the crystalline polyester nor the preparation of it was described in the patent. Also, that patent is not related to the current invention in that it used a glycidyl (meth)acrylate containing copolymer as the hardener, whereas in the current invention a polyphenoxy resin is mainly used.

In the present invention, particular semi-crystalline polyesters end-capped with a carboxylic acid anhydride are provided.

According to the present invention, low temperature powder coatings are obtained from a particular combination of a carboxylic acid group containing amorphous polyester, the carboxylic acid anhydride end-capped semi-crystalline polyester of the present invention, a glycidyl group containing polyphenoxy resin optionally in combination with one or more curing agents having functional groups reactable with the polyesters' carboxylic acid groups, and a catalyzing compound for the thermosetting reaction.

### SUMMARY OF THE INVENTION

According to the current invention there are provided new carboxyl acid anhydride end-capped semi-crystalline polyesters.

According to the current invention, there are also provided new thermosetting compositions which comprises:

(1) a carboxyl functional amorphous polyester (A)

(2) a carboxyl functional semi-crystalline polyester (B)

(3) a glycidyl group containing polyphenoxy resin (C)

(4) a glycidyl group containing acrylic copolymer (D)

(5) a curing catalyst

(6) a curing agent having functional groups reactive with the polyester carboxylic acid groups (E).

Said thermosetting compositions are for low temperature cure powder applications on metal and heat sensitive substrates, which provide excellent coating appearance and mechanical properties.

The current invention solves the problems of low flow, poor appearance and inferior mechanical properties encountered in conventional low temperature cure powder coatings.

### DETAILED DESCRIPTION OF THE INVENTION

The present invention provides particular carboxylic acid anhydride end-capped semi-crystalline polyesters. The acid anhydride end-capped semi-crystalline polyesters of the present invention can be used in thermosetting coating compositions.

Thus, according to the present invention there are provided new powdered thermosetting compositions for low temperature cure applications on metal and heat sensitive substrates, comprising as binder a mixture of a carboxyl group containing amorphous polyester, a carboxyl group containing semi-crystalline polyester, a glycidyl group containing polyphenoxy resin, a glycidyl group containing acrylic copolymer and a curing agent having functional groups reactive with the polyesters' carboxylic acid groups, characterized in that:

the carboxyl functional amorphous polyester (A) is composed of, referring to the diacid constituents, from 50 to 100 molar percent of terephthalic or isophthalic acid or their mixtures and from 50 to 0 molar percent of another aliphatic, cycloaliphatic or aromatic diacid, and, referring to the diol constituents, from 40 to 100 molar percent of neopentyl glycol and from 60 to 0 molar percent of another aliphatic or cycloaliphatic diol. Branching of the amorphous polyester is obtained by incorporation of a polyacid or polyol.

the carboxyl functional semi-crystalline polyester (B) is obtained from the ring-opening reaction of the anhydride group of a trimellitic and/or pyromellitic anhydride with a hydroxyl group containing semi-crystalline polyester (b), which is composed of, referring to the diacid constituents, from 70 to 100 molar percent of terephthalic acid, 1,4-cyclohexanedicarboxylic acid or a linear chain dicarboxylic acid containing 4 to 16 carbon atoms and from 30 to 0 molar percent of another aliphatic, cycloaliphatic or aromatic diacid, and, referring to the diol constituents, from 70 to 100 molar percent of a cycloaliphatic or a linear chain aliphatic diol containing 2 to 16 carbon atoms and from 30 to 0 molar percent of another aliphatic or cycloaliphatic diol .

the glycidyl group containing polyphenoxy resin (C) is from the Bisphenol A or from the phenol or cresol novolac type.

the glycidyl group containing acrylic copolymer (D) is composed of 10 to 90 molar percent of a glycidyl group containing monomer and from 90 to 10 molar percent of other monomers copolymerizable with the glycidyl group containing monomer.

the curing agent having functional groups reactive with the carboxylic acid groups of the polyesters (E) is a polyepoxy or β-hydroxyalkylamide compound.

The carboxyl functional amorphous polyesters (A) of the present invention have an acid number from 15 to 100 mg KOH/g and preferably from 30 to 70 mg KOH/g.

The carboxyl functional amorphous polyesters further are characterized by:

a number averaged molecular weight ranging from 1100 to 15000 and preferably from 1600 to 8500, measured by gel permeation chromatography (GPC)

a glass transition temperature (Tg) from 40 to 80° C., measured by Differential Scanning Calorimetry according to ASTM D3418 with a heating gradient of 20° C. per minute

an ICI cone and plate viscosity according to ASTM D4287-88, measured at 200° C. ranging from 5 to 15000 mPa.s.

The acid constituent of the amorphous polyester, according to the present invention, is from 50 to 100 molar percent composed of terephthalic or isophthalic acid or their mixtures and from 0 to 50 molar percent of another diacid constituent selected from one or more aliphatic, cycloaliphatic or aromatic diacids, such as: fumaric acid, maleic acid, phthalic anhydride, 1,4-cyclohexanedicarboxylic acid, 1,3-cyclohexanedicarboxylic acid, 1,2-cyclohexanedicarboxylic acid, succinic acid, adipic acid, glutaric acid, pimelic acid, suberic acid, azealic acid, sebacic acid, 1,12-dodecanedioic acid, trimellitic acid or pyromellitic acid , etc., or the corresponding anhydrides.

The glycol constituent of the amorphous polyester, according to the present invention, is from 40 to 100 molar percent composed of neopentyl glycol and from 0 to 60 molar percent of another glycol constituent selected from one or more aliphatic or cycloaliphatic glycols such as: ethylene glycol, propylene glycol, 1,4-butanediol, 1,6-hexane-diol, 1,4-cyclohexanediol, 1,4-cyclohexanedimethanol, 2-methyl-1,3-propanediol, 2-bu-tyl-2-ethyl-1,3-propanediol, hydrogenated Bisphenol A, hydroxypivalate of neopentyl glycol, trimethylolpropane, ditrimethylolpropane, pentaerythritol, etc.

The carboxyl functional semi-crystalline polyesters (B) of the present invention have a carboxyl number from 30 to 120 mg KOH/g and preferably from 50 to 100 mg KOH/g and more preferable from 70 to 100 mg KOH/g.

The carboxyl functional semi-crystalline polyesters are further characterized by:

a number averaged molecular weight ranging from 1100 to 17000 and preferably from 1400 to 11200

a fusion zone from 50 to 150° C., measured by Differential Scanning Calorimetry (DSC) according to ASTM D3418 with a heating gradient of 20° C. per minute

a glass transition temperature (Tg) of below 40° C., measured by Differential Scanning Calorimetry (DSC) according to ASTM D3418 with a heating gradient of 20° C. per minute

a degree of crystallinity, measured by Differential Scanning Calorimetry (DSC) according to ASTM D3415 of at least 5 J/g and preferably at least 10 J/g

an ICI (cone/plate) viscosity according to ASTM D4287-88, measured at 100° C. of at least 10 mPa.s.

The acid constituent of the semi-crystalline polyester, according to the present invention, is from 70 to 100 molar percent composed of terephthalic acid, 1,4-cyclohexanedicarboxylic acid or a linear chain dicarboxylic acid containing from 4 to 16 carbon atoms such as succinic acid, adipic acid, glutaric acid, pimelic acid, suberic acid, azelaic acid, sebacic acid, 1,10-decanedioic acid, 1,11 -undecanedioic acid, 1,12-dodecanedioic acid, 1,13-triadecanedioic acid, 1,14-tetradecanedioic acid, 1,15-pentadecanedioic acid, 1,16-hexadecanedioic acid , etc. used in a mixture or alone, and from 30 to 0 molar percent of another aliphatic, cycloaliphatic or aromatic diacid such as fumaric acid, maleic anhydride, phthalic anhydride, isophthalic acid, 1,3-cyclohexanedicarboxylic acid, 1,2-cyclohexanedicarboxylic acid, etc.

The glycol constituent of the semi-crystalline polyester, according to the present invention, is from 70 to 100 molar percent composed of a cycloaliphatic or linear-chain aliphatic diol containing 2 to 16 carbon atoms such as 1,4-cyclohexanediol, 1,4-cyclo-hexanedimethanol, hydrogenated Bisphenol A, 2,2,4,4-tetramethyl-1,3-cyclobutanol or 4,8-bis(hydroxymethyl)tricyclo[5.2.1.0]decane, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 14-tetradecanediol, 1,16-hexadecanediol, etc., used in a mixture or alone, and from 30 to 0 molar percent of another aliphatic glycol such as propylene glycol, neopentyl glycol, 2-methyl-1,3-propanediol, 2-butyl-2-ethyl-1,3-propanediol, hydroxypivalate of neopentyl glycol, etc.

The glycidyl group containing polyphenoxy resin (C) of the present invention is selected from the Bisphenol A based epoxy resins, phenol or cresol epoxy novolacs.

Bisphenol A based epoxy resins are typically prepared from the reaction of Bisphenol A and epichlorohydrin, wherein the excess of epichlorohydrin determines the number average molecular weight of the epoxy resin. See W. G. Potter: Epoxide Resins, Springer-Verlag, New York (1970) and Y. Tanaka, A. Okada, I. Tomizuka in C. A. May, Y. Tanaka (eds.): Epoxy Resins Chemistry and Technology, Chapter 2, pp. 9-134, Marcel Dekker, New York 1973.

The phenol and cresol epoxy novolacs are prepared by the acid-catalyzed condensation of formaldehyde with either phenol or cresol.

Epoxidation of the novolacs with epichlorohydrin furnishes the epoxy novolacs. Commercially available epoxy resins such as Epikote 1055 from Shell, Araldite GT7004 or Araldite ECN9699 from Ciba, D.E.R.664 from Dow and EPON 2002 from Shell are typical examples of glycidyl group containing polyphenoxies.

The glycidyl group containing acrylic copolymers (D) of the present invention have an epoxy equivalent weight of 1.0 to 5.0 milli-equivalents of epoxy/gram of polymer.

The glycidyl group containing acrylic copolymers are further characterized by:

a number averaged molecular weight ranging from 1000 to 15000

a glass transition temperature (T_{g}) from 40 to 85° C., measured by Differential Scanning Calorimetry (DSC), according to ASTM D3418 with a heating gradient of 20° C. per minute

an ICI cone and plate viscosity at 200° C. of at least 100 mPa.s

The glycidyl group containing monomer used to make the acrylic copolymer of the present invention is used in molar percentages ranging from 10 to 90 and is selected from the group of glycidyl acrylate, glycidyl methacrylate, methyl glycidyl methacrylate, methyl glycidyl acrylate, 3,4-epoxycyclohexylmethyl(meth)acrylate and acrylic glycidyl ether. They can be used alone or in mixtures of two or more.

Other monomers copolymerizable with the epoxy group containing monomer are used in molar percentages ranging from 10 to 90 and are selected from:

40 to 100 mole percentage of acrylic or methacrylic ester monomers such as methyl acrylate, ethyl acrylate, n-propyl acrylate, isopropyl acrylate, n-butyl acrylate, n-decyl acrylate, methyl methacrylate, ethyl methacrylate, n-propyl methacrylate, isopropyl methacrylate, n-butyl methacrylate, isobutyl methacrylate, n-amyl methacrylate, n-hexyl methacrylate, isoamyl methacrylate, allyl methacrylate, sec-butyl methacrylate, tert-butyl methacrylate, 2-ethylbutyl methacrylate, cinnamyl methacrylate, crotyl methacrylate, cyclohexyl methacrylate, cyclopentyl methacrylate, methallyl methacrylate, n-octyl methacrylate, 2-ethylhexyl methacrylate, 2-phenylethyl methacrylate and phenyl methacrylate.

0 to 60 mole percent of other ethylenically unsaturated copolymerizable monomers such as styrene, alkyl-substituted styrenes and chloro-substituted styrenes, acrylonitrile, vinyl chloride and vinylidene fluoride and vinyl acetate.

The curing agent (E) in accordance to the present invention, having functional groups reactive with the polyester's carboxylic acid groups, is selected from:

polyepoxy compounds, which are solid at room temperature and contain at least two epoxy groups per molecule, such as, for example, triglycidyl isocyanurate (TGIC) and Araldite PT910 or PT 912 both manufactured by Ciba.

β-hydroxyalkylamides which contains at least one, preferably two bis(β-hydroxy-alkyl)amide groups such as those mentioned in U.S. Pat. Nos. 4,727,111, 4,788,255, 4,076,917, EP 322,834 and EP 473,380.

The carboxylic acid group containing amorphous polyester (A) and the hydroxyl group containing semi-crystalline polyester (b), according to the present invention, are prepared using conventional esterification techniques well known in the art. The polyesters are prepared according to a procedure consisting of one or more reaction steps.

For the preparation of these polyesters, a conventional reactor equipped with a stirrer, an inert gas (nitrogen) inlet, a thermocouple, a distillation column connected to a water-cooled condenser, a water separator and a vacuum connection tube are used.

The esterification conditions used to prepare the polyesters are conventional, namely a standard esterification catalyst, such as dibutyltin oxide, dibutyltin dilaurate, n-butyltin trioctoate, sulfuric acid or a sulphonic acid, can be used in an amount from 0.05 to 1.50% by weight of the reactants and optionally, color stabilizers, for example, phenolic antioxidants such as Irganox 1010 (Ciba) or phosphonite- and phosphite-type stabilizers such as tributylphosphite, can be added in an amount from 0 to 1% by weight of the reactants.

Polyesterification is generally carried out at a temperature which is gradually increased from 130° C. to about 190 to 250° C., first under normal pressure, then, when necessary, under reduced pressure at the end of each process step, while maintaining these operating conditions until a polyester with the desired hydroxyl and/or acid number is obtained. The degree of esterification is monitored by determining the amount of water formed in the course of the reaction and the properties of the obtained polyester, for example, hydroxyl number, acid number, and viscosity.

The carboxylic acid group containing semi-crystalline polyester (B) is obtained by the ring opening reaction of the anhydride group of a carboxylic acid anhydride with the hydroxyl group of the hydroxyl group containing semi-crystalline polyester (b) at a temperature of from 120 to 200° C.

To the carboxylic acid group containing amorphous and semi-crystalline polyesters, crosslinking catalysts can optionally be added. These catalysts are added in order to accelerate crosslinking reactions of the thermosetting powder composition during curing. Examples of such catalysts include amines (e.g. 2-phenylimidazoline), phosphines (e.g. triphenylphosphine), ammonium salts (e.g. tetrabutylammonium bromide or tetrapropylammonium chloride), phosphonium salts (e.g. ethyltriphenylphosphonium bromide (BETP) or tetrapropylphosphonium chloride). These catalysts are preferably used in an amount of from 0.1 to 5% with respect to the weight of the binder.

According to the present invention, particular carboxylic acid anhydride end-capped semi-crystalline polyesters have been found. Thus according to the present invention, there are provided particular carboxylic acid anhydride end-capped semi-crystalline polyesters, characterized in that they are prepared from the ring-opening reaction of the anhydride group of at least one and preferably two mole(s) of a craboxylic acid anhydride, e.g. trimellitic anhydride, with one mole of hydroxyl functional prepolymers having hydroxyl numbers of from 15 to 70 mg KOH/g, which was prepared from the polycondensation of:

1,4-cyclohexanedicarboxylic acid and a linear chain aliphatic C2-C16 diol

a linear chain aliphatic C4-C16 diacid and a linear chain aliphatic C2-C16 diol or a cycloaliphatic diol

According to the present invention carboxylic acid anhydride end-capped semi-crystalline polyesters prepared from the ring opening reaction of two moles of anhydride with one mole of hydroxyl functional prepolymers prepared from the condensation of:

1,4-cyclohexandicarboxylic acid and ethylene glycol, 1,4-butanediol or 1,6-hexanediol

1,12-dodecanedioic acid and ethylene glycol, 1,4-butanediol, 1,6-hexanediol or 1,4-cyclohexanedimethanol

1,4-cyclohexanedimethanol and succinic acid, adipic acid or azelaic acid.

The trimellitic anhydride end-capped semi-crystalline polyester of the present invention has a sharp melting zone, a high degree of crystallinity, a high reactivity towards reactable groups of crosslinkers, and properties that are different from those found in the semi-crystalline polyesters known from anterior arts.

Used in the thermosetting powder coating compositions of the present invention, it provides high reactivity, excellent flow and good storage stability.

The glycidyl group containing acrylic copolymer (D) is prepared by conventional polymerization techniques, either in mass, in emulsion, or in the solution of an organic solvent. The nature of the solvent is very little of importance, provided that it is inert and that it readily dissolves the monomers and the synthesized copolymer. Suitable solvents include toluene, ethyl acetate, butyl acetate, xylene, etc. The monomers are copolymerized in the presence of a free radical polymerization initiator (benzoyl peroxide, dibutyl peroxide, azo-bis-isobutyronitrile, and the like) in an amount representing 0.1 to 4.0% by weight of the monomers.

To achieve a good control of the molecular weight and its distribution, a chain transfer agent, preferably of the mercaptan type, such as n-dodecylmercaptan, t-dodecanethiol, iso-octylmercaptan, or of the carbon halide type, such as carbon tetrabromide, bromotrichloromethane, etc., is also added in the course of the reaction. The chain transfer agent is used in amounts of up to 10% by weight of the monomers used in the copolymerization.

A cylindrical, double walled reactor equipped with a stirrer, a condenser, an inert gas (nitrogen, for example) inlet and outlet, and metering pump feeding systems is generally used to prepare the glycidyl group containing acrylic copolymer. Polymerization is carried out under conventional conditions. Thus, when polymerization is carried out in solution, for example, an organic solvent is first introduced into the reactor and heated to the refluxing temperature under an inert gas atmosphere (nitrogen, carbon dioxide, and the like) and a homogeneous mixture of the required monomers, the free radical polymerization initiator and the chain transfer agent, when needed, is then added to the solvent gradually over several hours. The reaction mixture is then maintained at the indicated temperature for certain hours, while stirring. The solvent is then removed from the copolymer obtained in vacuo.

The binder system of the thermosetting powdered composition of the present invention is composed of:

1 to 50 parts by weight of the carboxylic acid group containing amorphous polyester (A)

1 to 50 parts by weight of the carboxylic acid group containing semi-crystalline polyester (B)

1 to 90 parts by weight of a glycidyl group containing polyphenoxy resin (C)

0 to 85 parts by weight of the glycidyl group containing acrylic copolymer (D)

0 to 20 parts by weight of a curing agent having functional groups reactive with the polyesters' functional groups (E)

The binder system of the thermosetting composition of the invention thus is composed in such a way that for each equivalent of carboxyl group present in the amorphous polyester (A) and semi-crystalline polyester (B), there is between 0.3 and 2.0 and preferably between 0.6 and 1.7 equivalents of epoxy groups from the polyphenoxy resin (C), optionally the acrylic copolymer (D) and the curing agent (E). The particular thermosetting polyester blend (A) & (B), can be obtained by dry blending the amorphous and the semi-crystalline polyester using a mechanical mixing procedure as available for the premixing of the powder paint constituents.

Alternatively, the amorphous and the semi-crystalline polyester can be blended in the melt using the conventional cylindrical double-walled reactor or by extrusion such as the Betol BTS40.

In addition to the essential components described above, compositions within the scope of the present invention can also include flow control agents such as Resiflow P-67 (Estron), Modaflow (Monsanto), Acronal 4F (BASF), etc., and degassing agents such as Benzoin (BASF) etc. To the formulation UV-light absorbers such as Tinuvin 900 (Ciba), hindered amine light stabilizers represented by Tinuvin 144 (Ciba), other stabilizing agents such as Tinuvin 312 and 1130 (Ciba), antioxidants such as Irganox 1010 (Ciba) and stabilizers of phosphonite or phosphite types, can also be used.

Both pigmented and clear lacquers can be prepared. A variety of dyes and pigments can be utilized in the composition of this invention. Examples of useful pigments and dyes are: metallic oxides such as titanium dioxide, iron oxide, zinc oxide and the like, metal hydroxides, metal powders, sulphides, sulphates, carbonates, silicates such as ammonium silicate, carbon black, talc, china clay, barytes, iron blues, lead blues, organic reds, organic maroons and the like.

The components of the composition according to the invention may be mixed by dry blending in a mixer or blender (e.g. drum mixer). The premix is then homogenized at temperatures ranging from 50 to 120° C. in a single screw extruder such as the BUSS-Ko-Kneter or a twin screw extruder such as the PRISM or APV. The extrudate, when cooled down, is ground to a powder with a particle size ranging from 10 to 150 μm. The powdered composition may be deposited on the substrate by use of a powder gun such as an electrostatic CORONA gun or TRIBO gun. On the other hand, well known methods of powder deposition such as the fluidized bed technique can also be used. After deposition the powder is heated to a temperature between 80 and 150° C., causing the particles to flow and fuse together to form a smooth, uniform, continuous, non-cratered coating on the substrate surface.

The following examples are submitted for a better understanding of the invention without being restricted thereto.

### EXAMPLE A

A trimellitic anhydride end-capped crystalline polyester was prepared based on the following mixture of ingredients:

| Ingredients | Parts by weight (g) |
|---|---|
| Dodecanedioic acid | 4127.2 |
| 1,4-butanediol | 1784.2 |
| Trimellitic anhydride | 721.3 |
| Fascat 4102¹ | 13.2 |

¹Fascat 4102 is butyltin tris(2-ethylhexanoate) available from Atofina.

The dodecanedioic acid, 1,4-butanediol and Fascat 4102 were charged to a reaction vessel and heated under a nitrogen atmosphere until all the ingredients melted. The temperature of the reaction mixture was gradually increased to 220° C. The mixture was stirred and held at 220° C. until an acid value of below 5 mg KOH/g was obtained. The reaction mixture was then cooled to 170-190° C. followed by the addition of the trimellitic anhydride. The temperature was maintained until the reaction mixture became clear and an acid value of 70-80 mg KOH/g was obtained. Vacuum was applied to remove water to push the polycondensation to completion. The reaction mixture was transferred from the vessel to a receiving container and allowed to cool to room temperature to give a solid product. The resultant polyester had an acid number of 78 mg KOH/g, a melt viscosity at 100° C. measured by Brookfield Cone and Plate Viscometer of 5.5 poise, a melting temperature measured by Differential Scanning Colorimeter (DSC) of 58.9° C.

### EXAMPLE B

A trimellitic anhydride end-capped crystalline polyester was prepared based on the following mixture of ingredients:

| Ingredients | Parts by weight (g) |
|---|---|
| Dodecanedioic acid | 3692.0 |
| 1,6-hexanediol | 2143.8 |
| Trimellitic anhydride | 729.3 |
| Fascat 4102 | 12.6 |

The dodecanedioic acid, 1,6-hexanediol and Fascat 4102 were charged to a reaction vessel and heated under a nitrogen atmosphere until all the ingredients melted. The temperature of the reaction mixture was gradually increased to 230° C. The mixture was stirred and held at 230° C. until an acid value of below 5 mg KOH/g was obtained. The reaction mixture was then cooled to 170-190° C. followed by the addition of the trimellitic anhydride. The temperature was maintained until the reaction mixture became clear and an acid value of 70-80 mg KOH/g was obtained. Vacuum was applied to remove water to push the polycondensation to completion. The reaction mixture was transferred from the vessel to a receiving container and allowed to cool to room temperature to give a solid product. The resultant polyester had an acid number of 76 mg KOH/g, a melt viscosity at 100° C. measured by Brookfield Cone and Plate Viscometer of 6.5 poise, a melting temperature measured by Differential Scanning Colorimeter (DSC) of 60.0° C.

### EXAMPLE C

A carboxylic acid group containing amorphous polyester was prepared based on the following mixture of ingredients:

| Ingredients | Parts by weight (g) |
|---|---|
| Terephthalic acid | 5389.1 |
| Adipic acid | 598.8 |
| Neopentyl glycol | 4130.2 |
| Trimellitic anhydride | 1198.8 |
| Fascat 4102 | 25.0 |

The terephthalic acid and adipic acid were charged to a reaction vessel containing molten neopentyl glycol and Fascat 4102 at a temperature of 150° C. and under a nitrogen atmosphere. The temperature of the reaction mixture was gradually increased to 230° C. The mixture was stirred and held at 230° C. until an acid value of below 5 mg KOH/g was obtained. Vacuum was applied to remove water to push the polycondensation to completion. The reaction mixture was then cooled to 170-190° C. followed by the addition of the trimellitic anhydride. The temperature was maintained until the reaction mixture became clear and an acid value of 70-82 mg KOH/g was obtained. The reaction mixture was transferred from the vessel to a receiving container and allowed to cool to room temperature to give a solid product. The resultant polyester had an acid number of 80 mg KOH/g, a melt viscosity at 175° C. measured by Brookfield Cone and Plate Viscometer of 90 poise, a glass transition temperature measured by Differential Scanning Colorimeter (DSC) of 63.3° C.

### EXAMPLE D

A glycidyl group containing acrylic copolymer was prepared based on the following procedure:

800 parts of n-butyl acetate are charged in a 5-litre, double walled flask equipped with a stirrer, a water-cooled condenser, an inlet for nitrogen and a thermocouple attached to a thermo-regulator. The flask content is then heated and stirred continuously while nitrogen is purged through the solvent. At 125° C. a mixture of 91 parts of tert-butylperoxybenzoate in 200 parts of n-butyl acetate are fed in the flask during 215 minutes with a peristaltic pump. 5 Minutes after the feeding, the other pump is started to feed the mixture of 284 parts of glycidyl methacrylate, 312 parts of butyl methacrylate and 312 parts of methyl methacrylate within 180 minutes. The total synthesis time was 315 minutes.

After evaporation of the n-butyl acetate an acrylic copolymer with following characteristics was obtained:

| ICI viscosity @200° C. | 400 poise |
|---|---|
| Mₙ | 2600 |

### EXAMPLE E

A pigmented low temperature cure powder coating composition was prepared based on the following mixture of ingredients:

| Ingredients | Parts by weight (g) |
|---|---|
| Example C | 136 |
| Crystalline Polyester prepared in Example A | 34 |
| EPON 2002 | 170 |
| TiO₂ | 150 |
| Resiflow P-67 | 5 |
| Benzoin | 2 |
| BETP | 1.5 |

The ingredients were pre-mixed, melt blended at 90° C. in a Prism TSE 16 PC Twin Screw Extruder. The extrudate was chilled and broken into flakes, which were particulated, classified and electrostatically sprayed onto metal or MDF panels and cured at 130° C. for 20 minutes. The properties of the resultant coating are reported in Table 1 below.

### EXAMPLE F

A pigmented low temperature cure powder coating composition was prepared based on the following mixture of ingredients:

| Ingredients | Parts by weight (g) |
|---|---|
| Example C | 127.5 |
| Crystalline Polyester prepared in Example B | 42.5 |
| EPON 2002 | 170 |
| TiO₂ | 149.5 |
| Resiflow P-67 | 5 |
| Benzoin | 3.5 |
| BETP | 2 |

The ingredients were pre-mixed, melt blended at 85° C. in a Prism TSE 16 PC Twin Screw Extruder. The extrudate was chilled and broken into flakes, which were particulated, classified and electrostatically sprayed onto metal or MDF panels and cured at 130° C. for 20 minutes. The properties of the resultant coating are reported in Table 1 below.

### EXAMPLE G

A pigmented low temperature cure powder coating composition was prepared based on the following mixture of ingredients:

| Ingredients | Parts by weight (g) |
|---|---|
| Example C | 127.5 |
| Crystalline Polyester prepared in Example B | 42.5 |
| EPON 2002 | 150 |
| Glycidyl acrylic copolymer of Example D | 20 |
| TiO₂ | 149.5 |
| Resiflow P-67 | 5 |
| Benzoin | 3.5 |
| BETP | 2.0 |

The ingredients were pre-mixed, melt blended at 90° C. in a Prism TSE 16 PC Twin Screw Extruder. The extrudate was chilled and broken into flakes, which were particulated, classified and electrostatically sprayed onto metal or MDF panels and cured at 130° C. for 25 minutes. The properties of the resultant coating are reported in Table 1 below.

TABLE 1

| | | | | Reverse | | |
|---|---|---|---|---|---|---|
| Example | Gloss | | | Impact | MEK Double | Visual |
| No. | 60° | 20° | DOI | (in. lb.) | Rubs | Appearance |
| E | 99.5 | 94.2 | 80 | 160 | >100 | smooth |
| F | 99.0 | 95.0 | 80 | 160 | >100 | smooth |
| G | 100.0 | 94.2 | 80 | 80 | >100 | fairly smooth |

We claim:

1. A carboxylic acid anhydride end-capped semi-crystalline polyester, which is prepared from the ring opening reaction of an anhydride group of at least one mole of an anhydride compound with one mole of hydroxyl functional prepolymer having a hydroxyl number of from 15 to 70 mg KOH/g and prepared from the condensation of:
a. 1,4-cyclohexanedicarboxylic acid and a linear chain aliphatic C2-C16 diol or
b. a linear chain aliphatic C4-C16 diacid and a linear chain aliphatic C2-C16 diol or a cycloaliphatic diol.

2. The carboxylic anhydride end-capped semi-crystalline polyester according to claim 1 wherein at least two moles of the anhydride compound are reacted with one mole of hydroxy functional prepolymer.

3. A thermosetting coating composition comprising a binder wherein 100 parts by weight of this binder comprises:
(A) 1 to 50 parts by weight of a carboxylic acid group containing amorphous polyester having an acid number of from 15 to 100 mg KOH/g.
(B) 1 to 50 parts by weight of a carboxylic acid group containing semi-crystalline polyester, said polyester comprising the reaction product of an anhydride of a polybasic organic carboxylic acid and a hydroxyl group containing semi-crystalline polyester.
(C) 1 to 90 parts by weight of a glycidyl group containing polyphenoxy resin having an epoxy equivalent weight of between 200 and 1000 g/equiv.
(D) 0 to 85 parts by weight of a glycidyl group containing (meth) acrylate copolymer having an epoxy equivalent weight of between 150 and 900 g/equiv.
(E) 0 to 20 parts by weight of a curing agent different from (C) and (D) and having functional groups reactable with the polyester (A) and (B) carboxylic acid groups.

4. The composition according to claim 3 wherein the carboxylic acid group containing amorphous polyester (A) is composed of from 50 to 100% mole of terephthalic acid or isophthalic acid or their mixtures and from 0 to 50% mole of an aliphatic, cycloaliphatic or aromatic polyacid different from terephthalic acid or isophthalic acid, referring to the polyacid constituents, and from 40 to 100% mole of neopentyl glycol and from 0 to 60% mole of another aliphatic and/or cycloaliphatic polyol referring to the polyol constituents.

5. The composition according to claim 3 wherein the carboxylic acid group containing semi-crystalline polyester (B) is obtained from the ring opening reaction of the anhydride group of trimellitic anhydride and/or pyromellitic anhydride with a hydroxyl group containing semi-crystalline polyester having a hydroxyl number of from 15 to 70 mg KOH/g, and comprising from 70 to 100% mole of terephthalic acid, 1,4-cyclohexanedicarboxylic acid or a linear chain dicarboxylic acid containing 4 to 16 carbon atoms and from 0 to 30% mole of another aromatic, aliphatic or cycloaliphatic polyacid, referring to the polyacid constituents, and from 70 to 100% mole of a cycloaliphatic or linear chain aliphatic diol containing 2 to 16 carbon atoms and from 0 to 30% mole of another aliphatic or cycloaliphatic polyol, referring to the polyol constituents.

6. The composition according to claim 3 wherein the glycidyl group containing polyphenoxy resin (C) is a Bisphenol A based epoxy resin or a phenol or cresol epoxy Novolac.

7. The composition according to claim 3 wherein the glycidyl group containing (meth)acrylate copolymer (D) is prepared from 10 to 90% mole of a glycidyl group containing monomer and from 90 to 10% mole of one or more monomer copolymerizable with the glycidyl group containing monomers, said (meth)acrylate copolymer having a number averaged molecular weight of from 1000 to 15000.

8. The composition according to claim 3 wherein the curing agent (E) is triglycidyl isocyanurate, diglycidyl terephthalate, triglycidyl trimellitate, or a mixture of them, or a β-hydroxyalkylamide group containing compound.

9. The composition according to claim 3 wherein the carboxylic acid group containing amorphous polyester (A) has the following properties:
a. a number averaged molecular weight of from 1100 to 15000,
b. a glass transition temperature (Tg) from 40 to 80° C. and
c. an ICI (cone/plate) viscosity at 200° C. ranging from 5 to 15000 mPa.s.

10. The composition according to claim 9 wherein the carboxylic acid group containing amorphous polyester (A) has an acid number of from 30 to 70 mg KOH/g.

11. The composition according to claim 9 wherein the carboxylic acid group containing amorphous polyester (A) has a number average molecular weight of from 1600 to 8500.

12. The composition according to claim 3 wherein the carboxylic acid group containing semi-crystalline polyester (B) has the following properties:
a. an acid number from 30 to 120 mg KOH/g
b. a number average molecular weight ranging from 1100 to 17000
c. a fusion zone from 50 to 150° C.
d. a glass transition temperature (Tg) below 40° C.
e. a degree of crystallinity of at least 5 J/g
f. an ICI (cone/plate) viscosity at 100° C. of at least 10 mPa.s.

13. The composition according to claim 12 wherein the acid number of (B) is from 50 to 100 mg KOH/g.

14. The composition according to claim 13 wherein the acid number of (B) is from 70 to 100 mg KOH/g.

15. The composition according to claim 12 wherein the number average molecular weight of (B) is from 1400 to 11200.

16. The composition according to claim 12 wherein the degree of crystallinity of (B) is at least 10 J/g.

17. The composition according to claim 3 wherein the glycidyl group containing acrylic copolymer (D) has the following properties:
a. a number average molecular weight ranging from 1000 to 15000
b. an epoxy equivalent weight of from 150 to 900 g/equiv.
c. a glass transition temperature (Tg) from 40 to 85° C., measured by Differential Scanning Calorimetry (DSC), according to ASTM D3418 with a heating gradient of 20° C. per minute
d. an ICI (cone/plate) viscosity determined by the ICI method at 200° C. of at least 100 mPa.s.

18. The composition according to claim 17 wherein the glycidyl group containing acrylic copolymer has an epoxy equivalent weight of from 200 to 490 g/equiv.

19. The composition according to claim 3 containing from 0.1 to 5.0 parts by weight, referring to 100 parts of binder, of a catalyzing compound selected from the group consisting of amine, phosphine, ammonium salt and phosphonium salt catalysts.

20. The composition according to claim 3 additionally containing:
a. UV-light absorbers and/or hindered amine light stabilizers
b. flow control agents and
c. degassing agents

21. A clear lacquer containing the thermosetting powder composition of claim 3.

22. The thermosetting powder coating composition of claim 3 additionally containing at least one of pigments, dyes and fillers.

23. A method for applying the thermosetting powder composition of claim 3 which comprises applying it by an electrostatic or friction charging spray gun or fluidized bed technique.

24. A coating for metallic and non-metallic surfaces which comprises the thermosetting powder composition of claim 3.

25. A coating for a heat sensitive substrate comprising the thermosetting powder composition of claim 3.

26. The coating for a heat sensitive substrate according to claim 25 wherein the substrate is selected from the group consisting of paper, cardboard, wood, fiber board, textiles, polycarbonates, poly(meth)acrylates, polyolefins, polystyrenes, polyvinylchlorides, polyesters, polyurethanes, polyamides, copolymers of acrylonitrile butadiene styrene and cellulose acetate butyrate.

27. An entirely or partially coated substrate, wherein the coating material used, is a powder coating composition containing the composition according to claim 3.

28. A carboxylic acid group containing semi-crystalline polyester which is the reaction product of a carboxylic acid anhydride and a hydroxyl group containing semi-crystalline polyester.
